(19) United States
(12) Patent Application Publication
(10) Pub. No.: US 2008/0187233 A1
(43) Pub. Date: Aug. 7, 2008

(54) Method and System Of Data Transfer Using Printed Media

(75) Inventor: Nathan D. Culbertson, Melissa, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 11/670,864

(22) Filed: Feb. 2, 2007

(51) Int. Cl. G06K 9/36

(52) U.S. Cl. 382/251; 382/232

(57) ABSTRACT

According to the teachings of the present disclosure, an apparatus and methods for transferring data are provided. In one embodiment, a method for transferring data includes encoding binary data of one or more files into a plurality of respective colors. The method also includes generating one or more graphical images of the encoded binary data. The one or more graphical images comprise the respective colors. In addition the method includes decoding the binary data from the one or more graphical images.

### TECHNICAL FIELD

This disclosure relates in general to data transfer and, in particular, to data transfer using encoded prints.

### OVERVIEW

It is often necessary to remove unclassified data from classified environments. Security restraints frequently preclude downloading unclassified data onto conventional digital media, such as digital versatile discs (DVD), for removal from the classified area. As a result, unclassified data is often printed, reviewed for release, removed from the classified area, and converted back to electronic form outside of the classified area. Conventional methods of transferring such data using paper media and converting the data back to electronic form is limited for a variety of reasons.

### SUMMARY OF THE EXAMPLE EMBODIMENTS

According to the teachings of the present disclosure, an apparatus and methods for transferring data are provided. In one embodiment, a method for transferring data includes encoding binary data of one or more files into a plurality of respective colors. The method also includes generating one or more graphical images of the encoded binary data. The one or more graphical images comprise the respective colors. In addition the method includes decoding the binary data from the one or more graphical images.

Technical advantages of some embodiments of the disclosure may include methods and systems for encoding data onto printed media and decoding the data back to original form with enhanced accuracy and efficiency. In some embodiments, the data may be encoded in binary format that enables the transfer of special characters, such as tabs, thereby enabling a bit for bit reconstruction of the original file's substance and formatting. In addition, transferring data in binary format may allow the transfer of compressed files, thereby reducing the volume of transferring media. In some embodiments, the volume may be reduced further by increasing the density of the encoded data. Various embodiments may encode data using colored images that are generally not readable without the proper decoding application.

It will be understood that the various embodiments of the present disclosure may include some, all, or none of the enumerated technical advantages. In addition other technical advantages of the present disclosure may be readily apparent to one skilled in the art from the figures, description, and claims included herein.

### BRIEF DESCRIPTION OF THE DRAWINGS

For a more complete understanding of the present disclosure and features and advantages thereof, reference is now made to the following description, taken in conjunction with the accompanying drawings, in which:

FIG. 1 shows a block diagram of one embodiment of a data transfer system according to the teachings of the present disclosure;

FIG. 2A illustrates a drawing of a printed output image that may be used by the system of FIG. 1 according to one embodiment of the present disclosure;

FIG. 2B illustrates an enlarged view of a portion of the printed output image of FIG. 2A according to one embodiment of the present disclosure;

FIG. 3A illustrates a flowchart of a method of transferring data that may be used with the system of FIG. 1 according to one embodiment of the present disclosure;

FIG. 3B illustrates a flowchart of a method of encoding data that may be used by the system of FIG. 1 according to one embodiment of the present disclosure; and

FIG. 3C illustrates a flowchart of a method of decoding the encoded data of FIG. 3B according to one embodiment of the present disclosure.

### DESCRIPTION OF EXAMPLE EMBODIMENTS

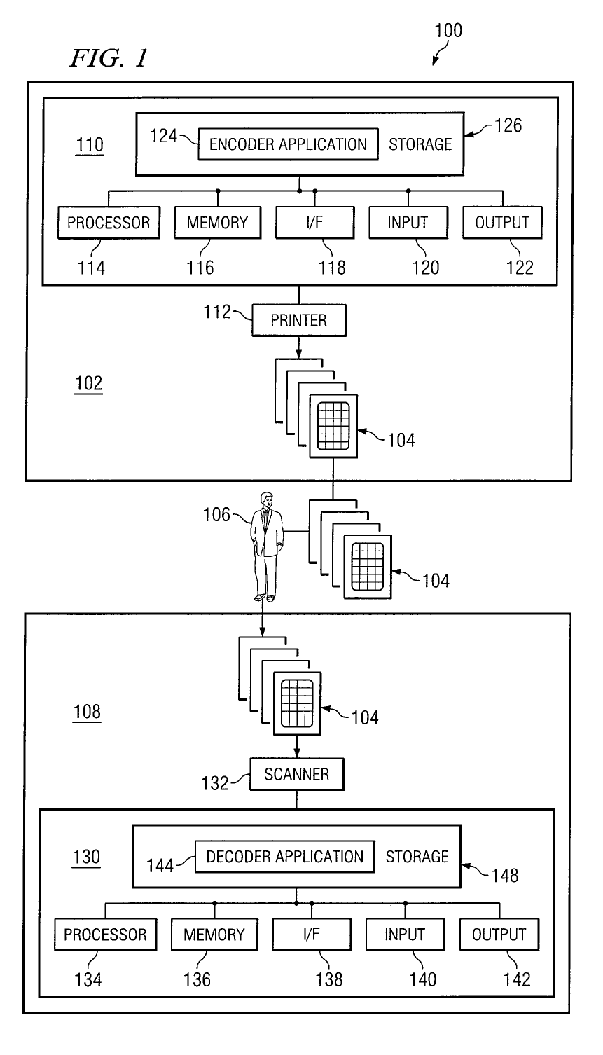

In accordance with the teachings of the present disclosure, methods and logic for transferring data are provided. In a particular embodiment of the present disclosure, printed color images may be used to transfer the binary data of a file from one computer to another. Embodiments of the present disclosure and its advantages are best understood by referring to FIGS. 1 through 3C of the drawings, like numerals being used for like and corresponding parts of the various drawings. Particular examples specified throughout this document are intended for example purposes only, and are not intended to limit the scope of the present disclosure.

FIG. 1 shows a block diagram of one embodiment of a data transfer system 100 according to the teachings of the present disclosure. In the example embodiment, data transfer system 100 generally includes an encoding station 102 operable to encode data into transferable media 104 that may be transferred by transporter 106 to a decoding station 108. As explained further below, in various embodiments, transferable media 104 may include binary data encoded into one or more graphical colored images printed on paper.

Conventional methods of converting printed media into electronic form are generally limited for a variety of reasons. For example, Optical Character Recognition (OCR) applications, which convert scanned ASCII text into electronic form, are typically limited by variations in scanners, printers, and differing character fonts. Many OCR applications advertise only 98% accuracy. Some of these errors result from OCR limitations in discerning the difference between characters, such as a numeral one “1” and a lower case L “1.” With thousands of pages of converted text that may each contain errors, the task of correcting them can become overwhelming. Other OCR limitations typically include the inability to transfer special characters, such as tabs, and a maximum of eighty characters per printed line of text. In addition, ASCII text may be more easily interpreted if intercepted.

Accordingly, teachings of some embodiments of the present disclosure recognize methods and systems for encoding data onto printed media and decoding the data back to original form with enhanced accuracy and efficiency. In some embodiments, the data may be encoded in binary format that enables the transfer of special characters, such as tabs, thereby enabling a bit for bit reconstruction of the original file's substance and formatting. In addition, transferring data in binary format may allow the transfer of compressed files, thereby reducing the volume of transferring media. In some embodiments, the volume may be reduced further by increasing the density of the encoded data. Various embodiments may encode data using colored images that are generally not readable without the proper decoding application.

In the example embodiment, encoding station 102 generally includes an encoder 110 communicatively coupled to a printer 112. Encoder 110 may include, for example, a server, a portable device, a computer workstation, or any other device operable to encode data onto transferable media 104. In the example embodiment, encoder 110 is a computer workstation including a processor 114, memory 116, an interface 118, input functionality 120, output functionality 122, and an encoder application 124 residing in storage 126.

Encoder application 124 may execute with any suitable MS-DOS, PC-DOS, OS-2, MAC-OS, WINDOWS™, UNIX, or other appropriate operating systems, including future operating systems. In the example embodiment, encoder application 124 is a WINDOWS™-based application operable to encode the binary data of one or more inputted files into colored segments that make up one or more output images, depending on the size of the file(s) to be transferred.

In the example embodiment, printer 112 generally refers to any suitable colored printer operable to print the encoded output image(s) to produce transferable media 104 in paper form. As explained further below, each sheet of transferable media 104, in the example embodiment, typically includes an image area containing the encoded binary data, a header, and alignment marks. In the example embodiment, the transferable media 104 printouts are hand carried by transporter 106 to decoding station 108.

In the example embodiment, decoding station 108 generally includes a decoder 130 communicatively coupled to a scanner 132. In the example embodiment, scanner 132 generally refers to any suitable colored scanner operable to scan the transferable media 104 printouts into electronic form, which may be communicated to decoder 130.

Decoder 130 may include, for example, a server, a portable device, a computer workstation, or any other device operable to decode the electronic form of the transferable media 104 communicated by scanner 132. In the example embodiment, decoder 130 is a computer workstation including a processor 134, memory 136, an interface 138, input functionality 140, output functionality 142, and a decoder application 144 residing in storage 148.

Decoder application 144 may execute with any suitable MS-DOS, PC-DOS, OS-2, MAC-OS, WINDOWS™, UNIX, or other appropriate operating systems, including future operating systems. In the example embodiment, decoder application 144 is a WINDOWS™-based application operable to decode the data encoded within the electronic scans of transferable media 104.

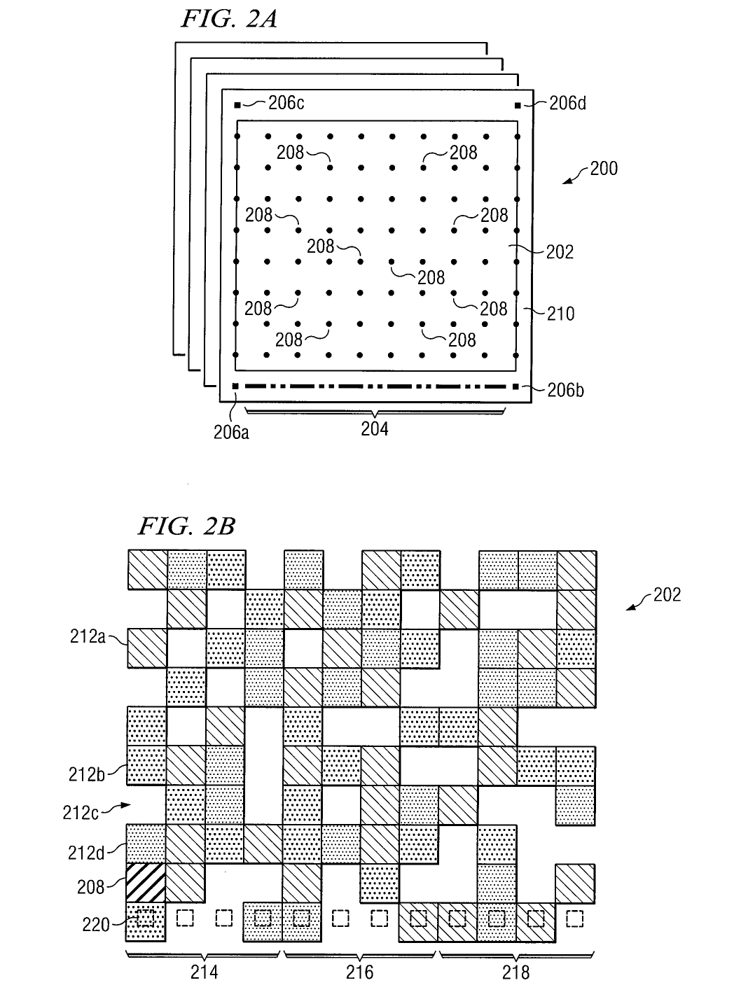

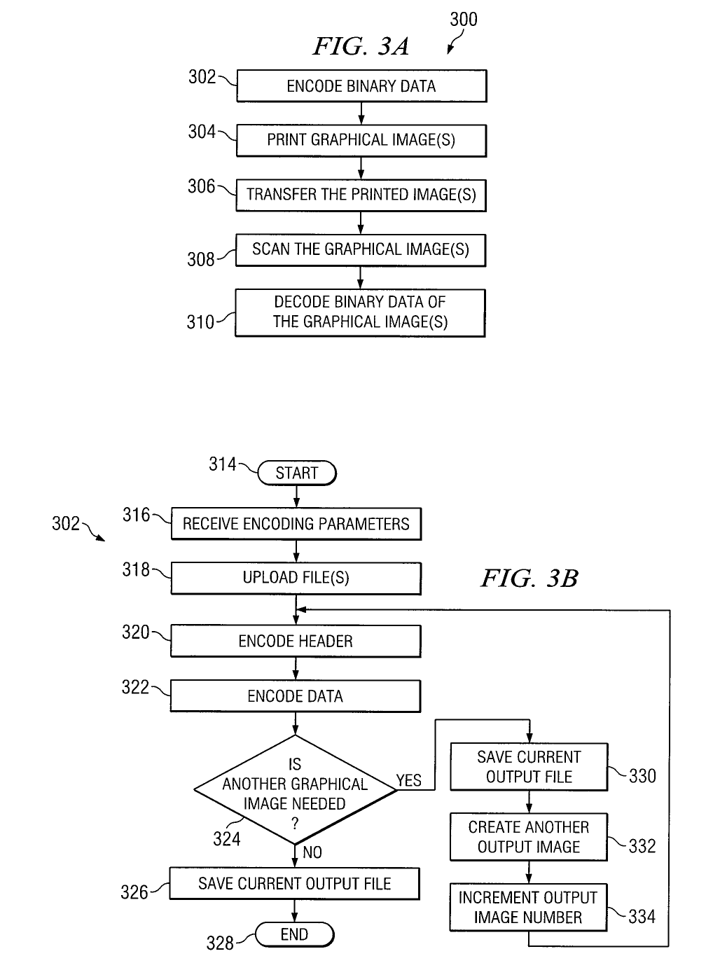

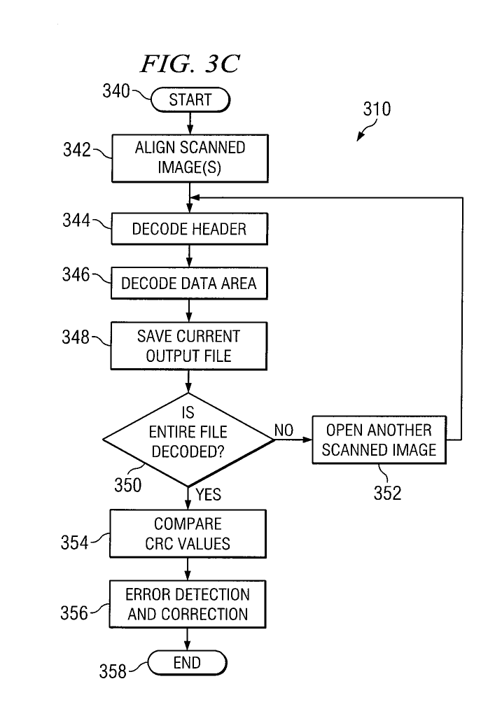

Additional details are further explained with reference to FIGS. 2A through 3C.

FIG. 2A illustrates a drawing of a printed output image 200 that may be used as a portion of the transferable media 104 of FIG. 1 according to one embodiment of the present disclosure. Printed output image 200 generally includes a data area 202, a header 204, page alignment marks 206, and data alignment marks 208, all printed on a sheet of paper 210. In the example embodiment, page alignment marks 206 are generally positioned in each corner of the output image 200 and are used for aligning the page during the decoding process.

In the example embodiment, a header 204 corresponding to the data area 202 is printed on the bottom of every output image 200. Header 204 may contain information that is not necessarily contained in the input file(s), but helps in the transfer of the input file(s). As shown in FIG. 2A, header 204 starts and ends with page alignment marks 206a and 206b respectively. Page alignment marks 206a and 206b represent the bottom left and bottom right boundary of the output image 200 respectively. One or more blank segment separates page alignment block 206a and 206b from header 204. Additional details regarding header 204 are explained further below.

Data area 202 generally contains the encoded binary data of the input file. In the example embodiment, data area 202 starts two rows above the header 204 line. This leaves a blank row between header 204 and the data segments at the bottom of data area 202. A grid of data alignment marks 208 may be used during the decoding process to synchronize and align the data segments of the data area 202.

FIG. 2B illustrates an enlarged view of a portion of the data area 202 of FIG. 2A according to one embodiment of the present disclosure. As shown in FIG. 2B, portion 202 generally includes a two-dimensional, twelve-by-twelve graphical arrangement of data segments 212 (e.g., data segments 212a, 212b, 212c, and 212d). Although data segments 212 are illustrated as square blocks, any appropriate shape or combination of shapes may be used.

In the example embodiment, data segments 212a, 212b, 212c, and 212d represent binary bits 00, 10, 11, and 01 respectively. In this manner, a sequence of four segments represents a byte (8 bits). To illustrate, byte 214 represents byte value 0XBD or 10111101b, byte 216 represents 0c7C or 01111100b, and byte 218 represents 0x13 or 00010011b. Each data segment 212a, 212b, 212c, and 212d is assigned a unique color (e.g., red, white, blue, and green). In the example embodiment, data segment 212c is white in color, which may be effected during printing by defining a space absent any marking. Although the example embodiment uses four unique data segments 212a, 212b, 212c, and 212d, any appropriate number of unique data segments may be used. For example, other embodiments may alternatively use sixteen uniquely colored segments, each representing a particular hexadecimal number. In addition to the four colors representing respective data values, the example embodiment uses black to represent data alignment marks 208; however, any appropriate color may be used. Data alignment marks 208 may be used for synchronization and alignment throughout data area 202. Areas 220 define a respective portion of each color segment used for decoding purposes.

In the example embodiment, header 204 contains information that facilitates the file transfer process. For example, header 204 may include snippets of encoded information for various decoding purposes, each snippet separated by a data alignment mark 208. The snippets may be encoded in header 204 using data segments, as explained further below. Although the snippets may vary from embodiment to embodiment, each output image 200 header 204 of the example embodiment includes the following example snippets listed below in respective order from left to right.

A calibration snippet contains a color segment corresponding to each of the particular colors of output image 200 for color calibration purposes. A revision snippet includes bytes representing the major and minor revision numbers. The revision numbers may be, for example, single byte values allowing versions from 0.0 to 255.255. In the example embodiment, these revisions numbers enable the decoding process to determine the encoding version.

A dimension snippet may store the maximum number of data segments 212 per row and column of data area 202. A dimension snippet stores the number of rows and columns (in data segments 212) within the data area 202. In the example embodiment, elements that are greater than a single byte may use Big Endian notation, allowing for machine independent operation.

A standard thirty-two bit CRC snippet facilitates error detection and correction associated with decoding process, as described in more detail below. A spacing snippet describes the spacing between data alignment marks 208, as described further below. A byte snippet describes the total number of bytes in the input file, which the example embodiment uses to determine how many bytes to extract from the image during the decoding process.

An image number snippet describes the respective number, starting at zero and incrementing for consecutive images. The example embodiment uses the image number to index the output images during the decoding process. A filename length snippet describes the total number of bytes contained in the filename. A filename snippet describes the filename and file extension of the respective input file. The example embodiment uses the filename snippet to correlate filenames of the inputted files to respective decoded files. In the example embodiment, several blank segments may separate the rightmost snippet of header 204 and page alignment block 206b, which is aligned with the rightmost column of output image 200.

The above snippets are for example purposes. Any other appropriate snippet or header 204 arrangements may be used without departing from the scope of the present disclosure. A better understanding of encoding and decoding methods and associated logic may be had with reference to FIGS. 3A through 3C.

FIG. 3A illustrates a flowchart 300 of a method of transferring data that may be used with the data transfer system 100 of FIG. 1 according to one embodiment of the present disclosure. Flowchart 300 begins at block 302 by encoding the binary data of one or more input files. In block 304, the encoded data is used to print graphical images. In the example embodiment, the images may be printed using any standard color printer and printer paper. However, in various embodiments, the type of paper and/or printer may affect the accuracy of the data transfer. For example, glossy photo paper may reduce the number of data bit errors compared to standard inkjet paper. In block 306, the printed graphical images are transferred. The transferred images are electronically scanned in block 308. The data of the electronic scans is then decoded in block 310.

FIG. 3B illustrates a flowchart 302 of a method of encoding data that may be used by the encoder application 124 of FIG. 1 according to one embodiment of the present disclosure. In general, the example embodiment encodes the binary data of one or more inputted files into one or more respective outputted images 200. Flowchart 302 starts in block 314.

In block 316, encoder application 124 receives encoding parameters, including, for example, a desired input file to encode, the input file location, and the desired dimensions of the output images 200. Various embodiments that allow a variable output image 200 size may enable the accommodation of differing printer capabilities. For example, modern printers have differing maximum Dots Per Inch (DPI) and margin capabilities. Thus, some embodiments that allow control over the output image 200 size may maximize the data density of each output image 200 based on the intended printer. In some embodiments, another encoding parameter received in block 316 may include the data segment 212 dimensions (in pixels). As with image size, this parameter may directly affect data density. That is, more data segments 212 may fit into an output image 200 with smaller data segment 212 dimensions. However, in some embodiments, as the data segment 212 is reduced passed a certain point, the accuracy rate of the decoding process may decrease, as discussed further below.

The input file or files are uploaded in block 318. Encoder application 124 encodes the header 204 information of the first output image 200 in block 320. In the example embodiment, header 204 includes the snippets described previously with reference to FIG. 2A, including the image number snippet, which is zero for the first output image 200.

Encoder application 124 encodes data from the input file to the data area 202 of the output image 200 in block 322. As explained previously with reference to FIG. 2A, the data area 202 of each output image 200 is a two-dimensional area of data segments 212 and data alignment marks 208. Once the data alignment marks 208 are in place, encoder application 124 fills the data area 202 between the data alignment marks 208 with data segments 212 that encode the input file. The encoding process may be effected a byte at a time by reading a byte from the input file and converting it into an appropriately colored data segment 212. The encoded bytes may be positioned in the output image 200 from left to right, starting at the bottom of data area 202. Once the current data row is filled with data, encoder application 124 begins filling data on the next row. This process continues until the entire input file has read, converted to colored data segments 212, and encoded to the output image 200.

In block 324, a decision is made regarding whether another output image is needed. If not, the output file is saved in block 326, (which output file may include multiple output images), and flowchart 302 terminates in block 328. However, if the data area 202 becomes completely filled prior to reaching the end of the input file, encoder application 124 determines that another output image 200 is needed in block 324. The output file is then saved in block 330, another output image 200 is created in block 332, and the output image 200 number is incremented in block 334. Encoder application 124 then loops back to block 320 and encodes a new header to the new output image 200. The new header may use the image number snippet to index the incremented image number. Encoder application 124 then proceeds with encoding data in block 322 as previously described.

FIG. 3C illustrates a flowchart 310 of a method of decoding the encoded data of FIG. 3B from one or more electronically scanned output images 200 according to one embodiment of the present disclosure. The scanned output image(s) 200 can consist of a single image or a series of images depending on the size of the input file used to create them. In the example embodiment, the decoding process generally includes three stages performed on each electronically scanned output image 200. The three stages generally involve alignment, header decoding, and data decoding. Flowchart 310 begins in block 340.

In block 342, decoder application 144 aligns one or more electronically scanned output images 200. This process includes locating at least some of the alignment features of each output image 200 and storing the respective locations. In the example embodiment, the alignment features may include the page alignment marks 206 that define the boundary of a respective output image 200. In some embodiments, decoder application 144 may not assume anything about the size of a single data segment 212 when locating page alignment marks 206. In this manner, variables such as the graphical dimensions of the data area 202, the dots per inch (DPI) of the printer used, and the DPI of the scanner used, which may be user selectable, can change from output 200 to output image 200 without negatively affecting the alignment process of block 342.

In the example embodiment, decoder application 144 locates the page alignment marks 206 by assuming that the paper used is white and the page alignment marks 206 are black. The location process starts by locating the first and last “non-white” pixels in each row and column. This information is then used to find the outside lines of each page alignment mark 206 by assuming that they are the first horizontal and first vertical line moving out from each corner of the scanned image. Once the horizontal and vertical edges of each page alignment mark 206 have been located, this information is used to determine the location and size of each page alignment mark 206. This determination is effected, in the example embodiment, by running a derivative over a pixilated area slightly larger than the located edges of a respective page alignment mark 206. Decoder application 144 uses this information to determine which pixels are deemed the virtual edges. Once the virtual edges are determined, decoder application 144 stores the location of the four page alignment blocks 206.

In block 344, header 204 is decoded. In the example embodiment, decoder application 144 first roughly calculates the size of the respective data segments 212. This calculation may be effected by averaging the size of the four page alignment marks 206 located and stored in block 342. In the example embodiment, decoder application 144 temporarily uses this rough calculation until a more accurate data segment 212 size is determined.

In the example embodiment, the headers 204 of each electronically scanned output image 200 include all of the example information snippets described previously with reference to FIG. 2A. Decoder application 144 decodes these information snippets in their respective order from left to right, the snippets parsed by data alignment marks 208. For example, decoder application 144 may locate the data alignment mark 208 at the start of the calibration snippet using, for example, a correlator process described in detail below. Decoder application 144 may then read in the colors used for encoding. In the example embodiment, decoder application 144 makes no assumptions about what colors were used to create the output image 200 when reading the colors. In some embodiments, this lack of assumption may minimize the effects of printer and scanner inconsistencies, such as, for example, specific color representations. In the example embodiment, decoder application 144 stores and uses the color calibration data to determine the value represented by each data segment 212 for the remainder of the output image 200. These data segment 212 values may each be determined, for example, using a covariance equation.

In the example embodiment, a covariance equation allows the relative differences between colors of each pixel making up a color segment 212 to determine which calibration color the data segment 212 matches the closest. In some embodiments, using a covariance equation may minimize the effects that occur due to inconsistencies in actual color of each pixel in the printed and scanned images. The covariance equation may be applied, for example, using only the inner-third rows and columns of pixels making up a respective data segment 212 (e.g., reference 220 of FIG. 2B). In this manner, edge effects that can occur between data segments 212 of different colors may be minimized, in some embodiments. One particular example of logic for a covariance equation is listed below.

```
for (all pixels in the inner data segment)
{
  RG_Diff = abs(pixelColor.red −
pixelColor.green);
  RB_Diff = abs(pixelColor.red −
pixelColor.blue);
  GB_Diff = abs(pixelColor.green −
pixelColor.blue);
  for (i=0; i < # of calibration colors; i++)
  {
    lDiff =
      (RG_Diff − abs(calColor[i].red −
  calColor[i].green)) +
      (RG_Diff − abs(calColor[i].red −
calColor[i].green)) +
      (RG_Diff − abs(calColor[i].red −
calColor[i].green));
    if (lDiff < lMinDiff)
    {
        lMinIndex = i;
        lMinDiff = lDiff;
    }
  }
  lIndexCounts[lMinIndex]++;
}
```

In the example embodiment, decoder application 144 sets the color of each data segment 212 to the color segment from the calibration snippet that matched the most pixels in the inner area 220 of the data segment 212. The data segment 212 then assumes the value of the matching color segment from the calibration snippet.

In the example embodiment, decoder application 144 also decodes, in block 344, the dimension snippet from header(s) 204 using, for example, the covariance process described above. Some embodiments may use the dimension snippet information to recalculate the size of data segments 212. For example, decoder application 144 may use the location of page alignment marks 206 to determine the height and width of the output image 200 in pixels. As previously described, the dimension snippet may store the maximum number of data segments 212 per row and column of data area 202. Decoder application 144 may divide the dimensions of data area 202 in pixels by the respective maximum numbers of rows and columns from the information snippet. The dividends may provide a more accurate size calculation for data segments 212, thereby potentially reducing errors that might result from the decoding process. In the example embodiment, decoder application 144 completes block 344 of flowchart 310 when all the information snippets of header 204 have been decoded.

In block 346, decoder application 144 decodes data area 202. In the example embodiment, decoder application 144 locates and stores all data alignment marks 208 in data area 202. This location process may be effected, for example, using a difference squared image correlator. To illustrate, decoder application 144 may use a reference correlator window the size of a single data segment 212 and set every pixel in the reference window to the particular data alignment mark 208 color. This window may then pass over the local area of the output image 200 near the expected location of the data alignment mark 208. Decoder application 144 may then deem the alignment mark 208 location congruent with the location having the minimum difference squared correlation value.

In some embodiments, decoder application 144 may use the location of one or more data alignment marks 208 to extrapolate the approximate location of other data alignment marks 208. This extrapolation may be effected, for example, using the spacing information from the spacing snippet in header 204. To illustrate, the number of data segments 212 between data alignment marks 208 may be read from the spacing snippet of header 204. This number may then be multiplied by the recalculated data segment 212 size to determine an estimate of where the next data alignment mark 208 is located. Decoder application 144 may then use the correlator process to refine the location of the data alignment block 208. In this manner, the furthest distance that decoder application 144 ever estimates is controlled by the spacing of data alignment marks 208. In some embodiments, minimizing this estimation distance may mitigate the effects of page skewing and inconsistencies from printing and/or scanning.

The stored positions of the data alignment marks 208 may be used to maintain accuracy during the data decoding process of block 346. For example, decoder application 114 may divide data area 202 into sub-arrays. The four corners of each sub-array may be bounded by respective data alignment marks 208, which may collectively establish the sub-array dimensions, including the local vertical and horizontal slopes. The sub-array dimensions may refine the local data segment 212 size calculation using previously described techniques. The slope information and recalculated data segment 212 size may further minimize page skewing effects and printing or scanning inconsistencies.

In the example embodiment, decoder application 144 runs the processes associated with block 346 for the entire data area 202, thereby reconstructing the binary data of the input file. Decoder application 144 then saves the decoded binary data into the output file in block 348. In block 350, a determination is made regarding whether all of the output images 200 for a particular input file have been decoded. If some output images 200 have not been decoded, decoder application 144 opens another scanned image in block 352 and loops back to block 344. However, if the binary data for all scanned output images have been read, the CRC value of the decoded output file is compared to the CRC value from the header 204 to determine if the transfer was successful in block 354.

In some embodiments, error detection and correction is then performed in block 356. The error detection and correction of block 356 may be effected by any of a variety of means. For example, if known errors occur in the transfer process, the extracted output file may be returned to the source. Some high security environments allow bringing electronic media into a secured area, even if such media cannot be taken out. In the example embodiment, the output file is returned to encoding station 102 and uploaded to workstation 110. Encoder application 124 then may perform a binary diff of the two files and create a text file containing the byte offset and correct value of each difference in the file. This text file can then be printed and removed from the classified area. Once outside, a hex editor tool can be used to correct the errors that may have been introduced during the data transfer process. Flowchart 310 then terminates in block 358.

Thus, in various embodiments, the methods and system of the present disclosure may efficiently transfer reams of data with little or no error using color coded paper media. Although the present disclosure has been described in several embodiments, a myriad of changes, variations, alterations, transformations, and modifications may be suggested to one skilled in the art, and it is intended that the present disclosure encompass such changes, variations, alterations, transformations, and modifications as falling within the spirit and scope of the appended claims.

What is claimed is:

1. A method of transferring data comprising:
encoding binary data of one or more files into a plurality of respective colors;
generating one or more graphical images of the encoded binary data, the one or more graphical images comprising the respective colors; and
decoding the binary data from the one or more graphical images.

2. The method of claim 1, and further comprising:
detecting errors in the decoded one or more graphical images; and
correcting the detected errors.

3. The method of claim 1, wherein generating one or more graphical images of the encoded binary data comprises generating the one or more graphical images using a plurality of colored blocks each representing respective ones of the plurality of respective colors.

4. The method of claim 1, wherein encoding binary data of one or more files into a plurality of respective colors comprises encoding an even number of bits into each of the plurality of respective colors.

5. The method of claim 1, wherein encoding binary data of one or more files into a plurality of respective colors comprises encoding binary data of one or more files into at least four respective colors.

6. The method of claim 1, and further comprising:
generating one or more headers proximate one or more perimeters of the generated one or more graphical images;
scanning the generated one or more graphical images;
aligning the scanned one or more graphical images using at least a portion of the one or more headers; and
calibrating the colors of the plurality of respective colors using at least a portion of the one or more headers.

7. The method of claim 6, and further comprising encoding information in the one or more headers, the encoded information selected from the group consisting of:
a software revision;
a number of respective rows of the plurality of respective colors for each graphical image of the one or more graphical images;
a number of respective columns of the plurality of respective colors for each graphical image of the one or more graphical images;
a respective CRC value of each of the one or more files;
a spacing of the portion of the one or more headers used to align the scanned one or more graphical images;
a total number of respective bytes of the encoded binary data of each of the one or more files;
a respective image number of each of the one or more graphical images;
a respective length of the filename of each of the one or more files;
a respective filename of each of the one or more files; and
a respective file extension of each of the one or more files.

8. The method of claim 1, and further comprising determining the respective color of each of the plurality of respective colors using a covariance equation.

9. Logic encoded in computer readable media, the logic operable to:
encode binary data of one or more files into a plurality of respective colors; and
generate one or more graphical images of the encoded binary data, the one or more graphical images comprising the respective colors

10. The logic of claim 9, wherein the logic is further operable to decode the binary data from the one or more graphical images.

11. The logic of claim 10, wherein the logic is further operable to:
detect errors in the decoded one or more graphical images; and
correct the detected errors.

12. The logic of claim 9, wherein the logic is further operable to:
receive a selection for the maximum dimensions of the one or more graphical images; and
receive a selection for the dimensions of the plurality of respective colors.

13. The logic of claim 9, wherein the logic is further operable to generate the one or more graphical images using a plurality of colored blocks each representing respective ones of the plurality of respective colors.

14. The logic of claim 9, wherein the logic is further operable to:
generate one or more headers proximate one or more perimeters of the generated one or more graphical images;
scan the generated one or more graphical images;
align the scanned one or more graphical images using at least a portion of the one or more headers; and
calibrate the colors of the plurality of respective colors using at least a portion of the one or more headers.

15. The logic of claim 14, wherein the logic is further operable to encode information in the one or more headers, the encoded information selected from the group consisting of:
a software revision;
a number of respective rows of the plurality of respective colors for each graphical image of the one or more graphical images;
a number of respective columns of the plurality of respective colors for each graphical image of the one or more graphical images;
a respective CRC value of each of the one or more files;
a spacing of the portion of the one or more headers used to align the scanned one or more graphical images;
a total number of respective bytes of the encoded binary data of each of the one or more files;
a respective image number of each of the one or more graphical images;
a respective length of the filename of each of the one or more files;
a respective filename of each of the one or more files; and
a respective file extension of each of the one or more files.

16. Logic encoded in computer readable media, the logic operable to:
decode binary data encoded into a plurality of respective colors of one or more graphical images.

17. The logic of claim 16, wherein the logic is further operable to:
detect errors in the decoded binary data; and
correct the detected errors.

18. The logic of claim 16, wherein the logic is further operable to determine the respective color of each of the plurality of respective colors using a covariance equation.

19. The logic of claim 16, wherein the logic is further operable to decode one or more headers proximate one or more perimeters of the generated one or more graphical images.

20. The logic of claim 19, wherein the logic is further operable to decode information in the one or more headers, the decoded information selected from the group consisting of:
a software revision;
a number of respective rows of the plurality of respective colors for each graphical image of the one or more graphical images;
a number of respective columns of the plurality of respective colors for each graphical image of the one or more graphical images;
a respective CRC value of each of the one or more files;
a spacing of the portion of the one or more headers used to align the scanned one or more graphical images;
a total number of respective bytes of the encoded binary data of each of the one or more files;
a respective image number of each of the one or more graphical images;
a respective length of the filename of each of the one or more files;
a respective filename of each of the one or more files; and
a respective file extension of each of the one or more files.
